(19) United States
(12) Patent Application Publication
(10) Pub. No.: US 2001/0039490 A1
(43) Pub. Date: Nov. 8, 2001

(54) System and method of analyzing and comparing entity documents

(76) Inventors: Mikhail Verbitsky, Stoughton, MA (US); Valery Tsourikov, Boston, MA (US); Leonid Batchilo, Belmont, MA (US)

Correspondence Address: STANGER & DREYFUS, 608 SHERWOOD PKWY, MOUNTAINSIDE, NJ, 07092, US

(21) Appl. No.: 09/821,847

(22) Filed: Mar. 29, 2001

Related U.S. Application Data
(63) Continuation-in-part of application No. 09/541,182, filed on Apr. 3, 2000.
(60) Provisional application No. 60/198,695, filed on Apr. 20, 2000.

(51) Int. Cl. G06F 17/27; G06F 17/30; G06F 17/21

(52) U.S. Cl. 704/9; 707/531; 707/3; 707/6

(57) ABSTRACT

A computer based system and method for acquiring sets of documents related to respective entities, processing the text of each document into subject, action, object (SAO) format, and displaying one or more S or AO folders in rank order in association with the respective entity to identify the activities, estimate each entity activity level with respect to specific Ss or AOs. In one example, technology activity and technical problem solving can be discerned and compared between entities.

### RELATED APPLICATION

U.S. Provisional Patent Application Ser. No. 60/198,695, filed Apr. 20, 2000.

### BACKGROUND

The advent of the worldwide web has made available to the public in digital form a vast amount of government, corporate and other entity technical and non-technical of all types. This information, resident in huge databases owned or managed by government and corporate entities, is generally available for public or private use either as a free service or for a download, subscription, or other fee.

A strong need exists for various companies, entities to use this information to analyze the activity of various entities, collection of entities, government agencies, industry segments, trade association, scientific, and other societies, etc., (hereafter “entity” or “entities”). For example, the board of directors of company A may want to know (independently of internal company reports) how active the company has been in developing a particular product or technology and how active its competitor company B has been in the same field. At present, information available on the net can be searched for information that relates to the mission by accessing the U.S. Patent & Trademark Office patent database and other on-line databases containing technical articles, journals, products announcements, and even SEC filings for merger and acquisition information.

A serious problem the user immediately encounters is the inability to reliably search for and find the precise information under consideration. Although Boolean search techniques are provided by the database management companies, such technologies produce too many documents for the user's consideration which often wastes user time and cause user to abort the effort.

A second problem encountered relates to the organization and presentation of the results, which simply includes presentation of the document portions themselves in a purported order of significance. Since the user desires to select the specific documents of interest, user must wade through many words, sentences, etc. that are not directly relevant to the mission concept.

Fortunately, great strides have been taken to enable users to locate specific documented information of all types specifically, U.S. patent application Ser. No. 09/541,182 filed Apr. 3, 2000 discloses a new system and method of semantically processing natural language documents to build a Subject-Action-Object Knowledge Base (SAO KB) which is presented to the user in an efficient and effective manner. Accordingly, user can control the presentation of SAO folders organized either as problem folders AO's or as solution folders S's. Selection of a specific AO or S will display all Ss or AOs (respectively) stored in association with the selected common AO or S.

### SUMMARY OF EXEMPLARY EMBODIMENT OF THE PRESENT INVENTION

It is an object of the present invention to provide a system or method for automatically analyzing a set of documents residing in one or more local and/or remote databases having a relationship to a user entered criterion that relates to one or more entities activities or a segment of such activities from data in one or more SAO Knowledge Bases for each entity, organizing the access and display of such SAO Knowledge Bases such that common AOs or Ss are displayed for quick user understanding of potential activities for each entity under consideration. User selection of a displayed S or AO will cause the AOs or Ss respectively stored in association with the common selected S or AO. In a preferred embodiment, the displayed Ss, or AOs, for each entity are prioritized or ranked and displayed in order. For example, the Ss displayed in column form, the first S having the highest number of AOs associated therewith, the next S having the second highest number of AOs associated therewith, etc. This display quickly gives user a general idea of the subjects and therefore the technologies most appearing in documents under consideration and thus an indirect indication of the entity's activity or interest.

If user wants to see the detailed problems (or solutions) the entity uses the subject (S) to address, user simply selects an S folder and the AOs associated with the selected S are displayed thereunder or in visual association therewith.

As mentioned above, user can organize the displayed results by AOs in order of having the most to the least number of Ss associated with common AOs. This display quickly indicates to user the entities activities in addressing a specific problem or application.

To compare problem occurrence or technology occurrence between document sets of two or more companies, the present system can display the S-AO or AO-S folders in side-by-side display.

In addition, the number of documents (e.g., U.S. patents and published patent applications), can be counted and displayed in which the gross total of SAOs appear for each entity and for respective Ss or AOs within each displayed folder.

Also, if desired and as recommended, the initial count of SAOs and corresponding S and AO folder can include only those in the SAO Knowledge Base found in the summary of invention section and/or the detailed description section of processed patent and patent application texts. Thus, results yield more reliable data and conclusions since SAOs from the background (related to prior art) and claims (related to legal terminology) would not contribute to the final S-AO counts.

### DRAWINGS

Other and further objects and benefits of the present invention shall become apparent with the following detailed description when taken in view of the appended drawings in which:

FIG. 1 shows one example of a screen display of a system according to the principles of the present invention in which user can start a session of the method in a general purpose digital computer.

FIG. 2 shows one example of a screen display according to the principles of the present invention in which user has entered data to compare two entities' highest level of activities applied to specific problems.

FIG. 3 shows one example of a screen display according to the principles of the present invention in which user has entered data to compare two entities' solutions to the same problem.

FIG. 4 shows one example of a screen display according to the principles of the present invention in which user has entered data to compare two entities related to the respective use of the most used technical solution (subject).

FIG. 5 is similar to FIG. 4 after the user opens the most used solution folder to reveal the technical problems (AOs) associated with the solution(S).

FIG. 6 is a representation of one example of the principal stages of the system and method for implementing the present invention.

FIG. 7 is similar to FIG. 3 but includes a display of the total number of patent documents in each entity set, the number in the open file, and the number in the open sub-file.

### DETAILED DESCRIPTION OF EXEMPLARY EMBODIMENT

The following are incorporated herein by reference:

1. System and on-line information service presently available at www.cobrain.com and the publicly available user manual therefor.

2. The software product presently marketed by Invention Machine Corporation of Boston, USA, under it's trademark “KNOWLEDGIST” and the publicly available user manual therefor.

3. WIPO Publication 00/14651, Published Mar. 16, 2000.

4. U.S. patent application Ser. No. 09/541,182 filed Apr. 3, 2000.

5. IMC's COBRAIN® server software marketed in the United States and manuals therefor.

Assume user wants to analyze the photodetector technology of Honeywell and Canon and compare these two companies mutual approaches to solve problems associated with photodetectors or to compare these two companies' applications of photodetectors.

An exemplary method according to the principles of the present invention includes user developing an SAO Knowledge Base (KB) generated, for example, by semantically processing natural language document data pursuant to references nos. 2, 4, or 5 above. Specifically, user uses this general purpose computer based system to access and process first and second sets of source documents that identifies Honeywell and Canon.

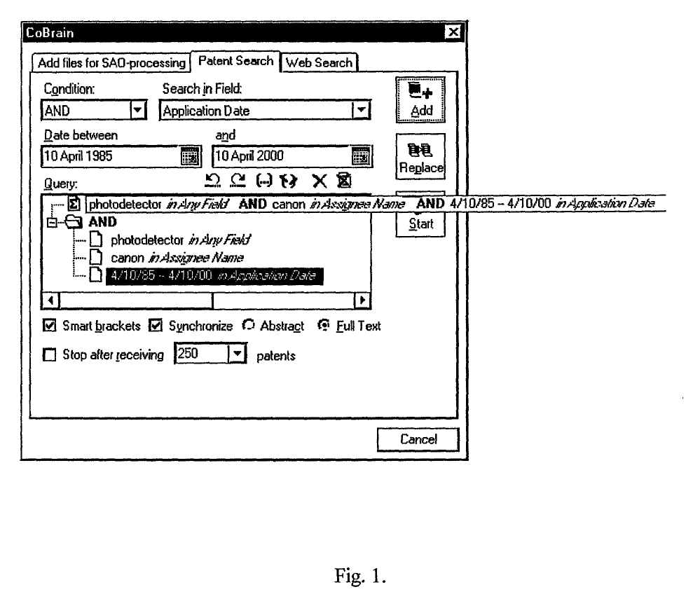

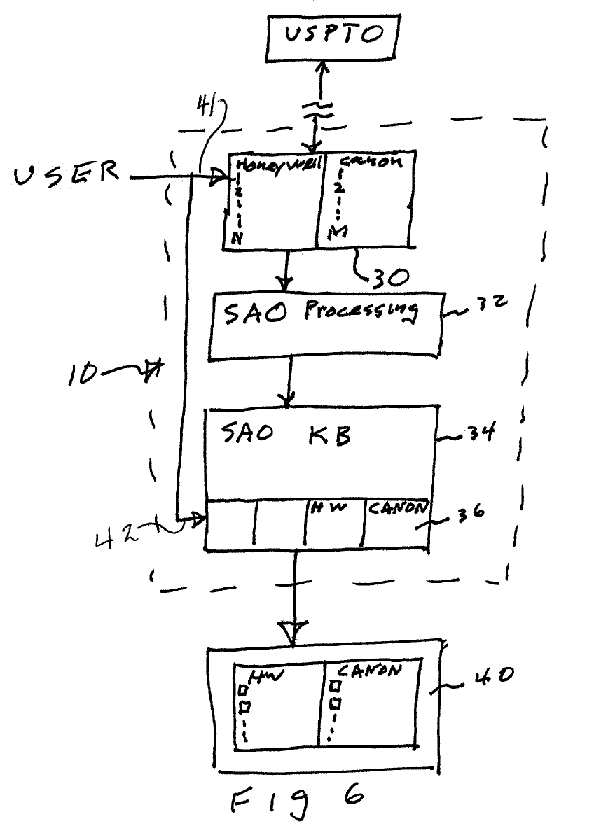

For example, in FIGS. 1 and 6, user conducts a computer search of on-line database documents (e.g. U.S. Patent & Trademark Office on-line searchable patent and published patent application database files) for the patents filed between Apr. 10, 1985-Apr. 10, 2000. User entered a first request 41 into his/her computer 10 that includes the present software, “photodector” as a topic, “Canon” as assignee and the period of interest as a user search criterion or query. Relevant Canon documents are downloaded to storage 30, read, i.e., processed into SAO structures in unit 32 and stored with links to the source sentence and document in SAO Knowledge Base 34. Results of the analysis (e.g., canon.cob) can be saved in a separate computer file 36. These steps are repeated for every set of documents (e.g., for every competing company such as Honeywell) user is interested in. As seen below user can manage SAO data and display it on monitor 40 or print, transmit it, etc. on the user's computer peripherals, not shown. User can, upon a second user command 42, also manage (open, close folders) the displayed data and obtain the displayed information on monitor 40.

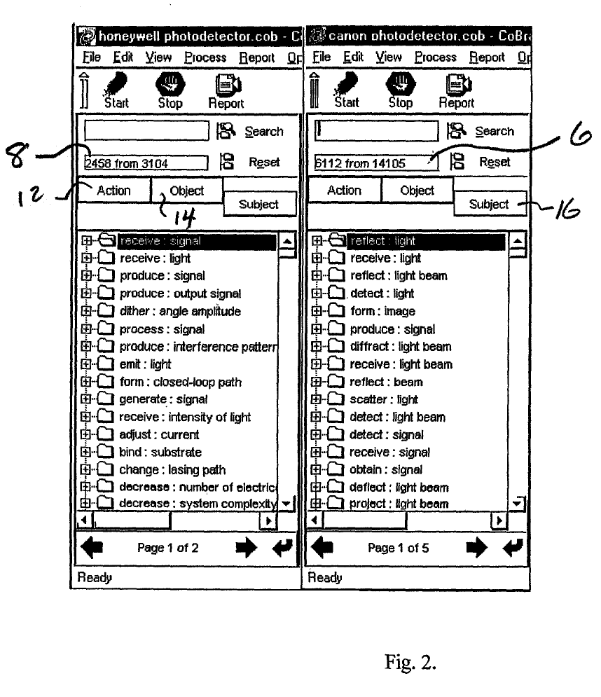

User can operate the system to manage data and build conclusions about the technical activities of respective companies indicated in the analyzed documents and, if desired, compare one company's documented activities against the other. To identify major problems addressed in the processed documents user, by the S-A-O mapping buttons 12, 14, 16, selects Problem-Solution structure, here folders have action-object (AO) name and filled by subjects (S). See references no. 4 for further details of the mapping button function. Folders are sorted according to numbers of solutions they contain. For comparison, sorted in such manner files are displayed together such as shown in FIG. 2.

Note the Honeywell and Canon problem (AO) folders are displayed side by side. The system counts the number of SAO's from all processed documents and displays this number. Note in window 6 Canon patents relating to “photodector” filed in the period have 14,105 SAOs where Honeywell patents have 3,104 SAOs displayed in window 8. The smaller number 6, 8 (6112,2458 respectively) indicates the number displayed on the currently displayed page.

The system also determines the number of subjects (Ss) each common AO and display the AOs in rank order of most Ss to least Ss within the respective folder.

Note in FIG. 2 that user immediately understands that Honeywell applies highest activity to technical problems of receiving signals, receiving light, producing signals etc, whereas Canon applies highest activity to light reflection, receiving, detection, etc.

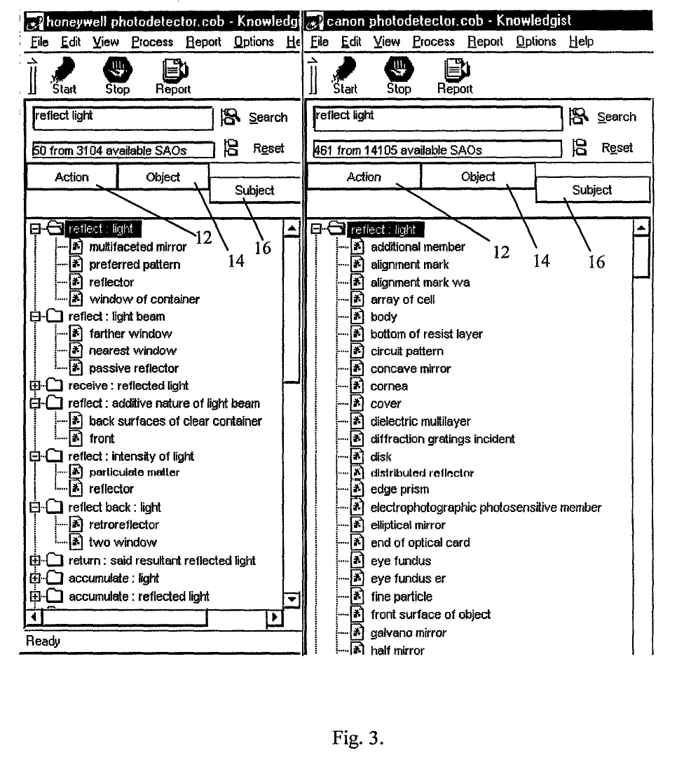

User can also compare how these companies solve the same technical problem. User simply selects the same problem folder for each company, e.g., “reflect:light” in FIG. 3. Note Honeywell has four folders related to this choice, so user can open all four folders to see the subjects (solutions) Honeywell used to perform the function reflect light. User also selects the “reflect:light” folder for Canon so that all Ss thereunder are displayed. Note Honeywell lists 50 SAOs having reflect light or a variant as an AO and Canon has 461 SAOs having reflect light or a variant thereof as an AO.

User can see from this FIG. 3, the various and extent of solutions (Ss) each company used to generate the function reflect light.

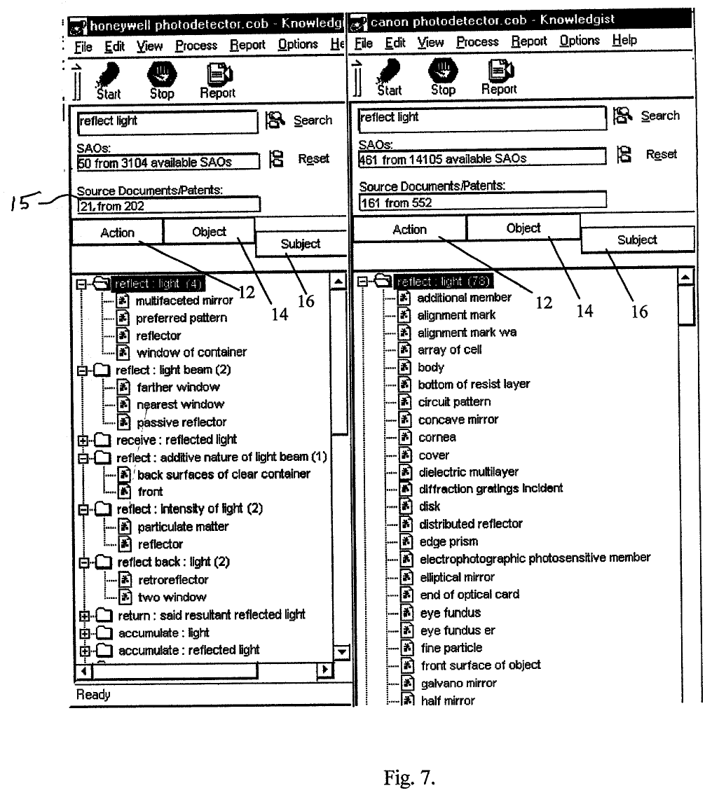

If desired, the system can simply count and manage the gross number of patents (documents) from which the total SAOs derive in each entity set and the number of patents associated with each of the open folders. For example, note in window 15 of FIG. 7, total Honeywell patents is 202 for the set, while 21 patents are the source for the SAOs of the 5 open folders shown. Further 4 patents and 2 patents, respectively, are the source documents for the “reflect:light” and “reflect:light beam” folders.

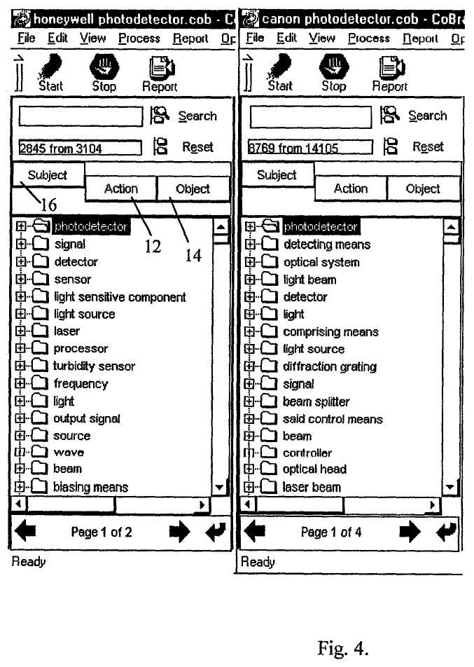

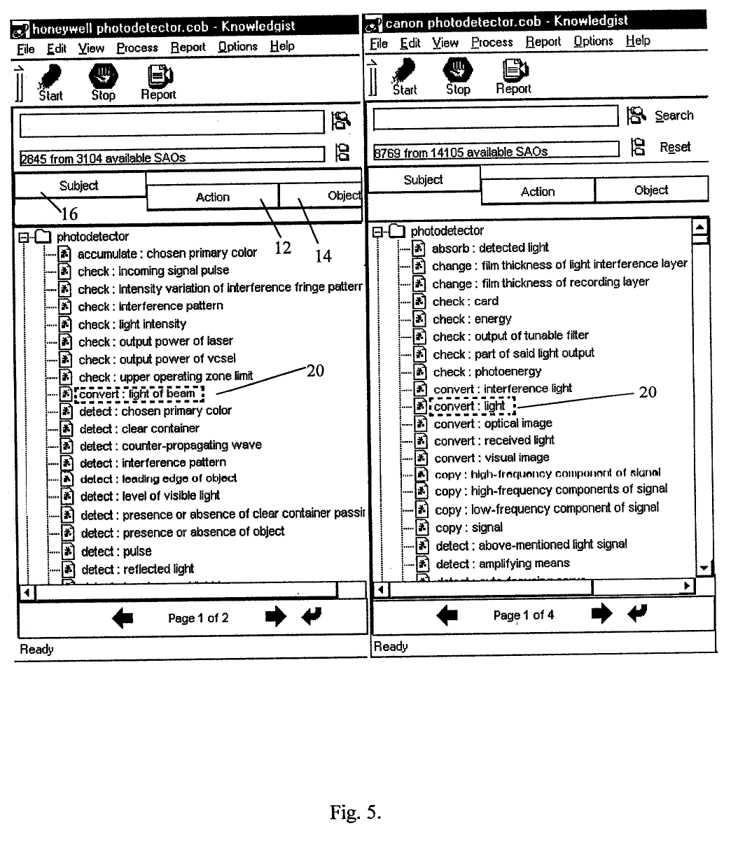

To identify major technologies in two sets of documents, user uses Solution-Problem (S-AO) structure which user controls by the S-A-O mapping buttons. Folders have subject (S) name and filled by action-objects (AO). Folders are preferably sorted according to numbers of AOs they contain -highest to lowest. For comparison, files sorted in such manner are displayed as shown in FIG. 4. Note both companies have “photodector” technical element to generate the greatest number of functions (AOs). The others are shown in rank order of number of AOs associated with the respective S. Visual or numerical analysis allows comparison of major technologies described in the two sets of documents. For similar technologies, user compares their different applications described in the two sets of documents. See FIG. 5.

In FIG. 5, user selected (opened) “photodector” folder for each company to see and compare the problems or functions (AOs) the selected S addressed in the two document sets. These AOs are listed alphabetically and user can see that Honeywell used a “photodector” to “check: output power of laser” and that Canon's documents does not mention this use of a photodector. Also, Canon uses the device to check “output of tunable filter” but Honeywell's documents do not.

User can also note that both companies use photodetector to “convert light”. The system can highlight with color or otherwise to denote common AOs for the entities displayed. This color highlighting is represented by the dashed boxes 20. These folders can be selected or opened to access the source sentence and the identity of the source document from which the SAOs were extracted thus revealing more detail of the photodector system each company used to convert light and/or into what light was converted along with a link to the full document. User selecting the link causes access to the full document. See, for example, reference nos. 1 and 2, above.

User can also note that Canon uses a photodetector to ‘copy’ signals and copy high and low frequency signal segments. Honeywell, however, does not employ this physical effect in the documents accessed.

Thus, user can obtain many ideas and much information from the information displayed in accordance with the principles of the present invention. Although, the above example provides a comparison between two sets of documents, it will be understood that a third or more company's documents can be processed and displayed for a three or more document set comparison, if desired, in accordance with the present invention.

Other and further changes and improvements can be made to the herein disclosed exemplary embodiments without departing from the spirit and scope of the present invention.

It should be understood, also, that since the processed S-A-O extractions result from semantically processing, accessed natural language documents, this system is not limited to technical documents, such as patents, but can effectively be applied to marketing, financial, manufacturing, personnel, and other entity downloaded or electronically stored documents and subject matters thereof, as well.

It should also be understood that the above mentioned numbers of Ss-AOs-SAOs and those shown in the figures are actual numbers appearing in the full text of the stated Honeywell and Canon patents for the stated subject matter and time period down loaded from the U.S. Patent & Trademark Office searchable patent database. These companies and actual numbers were used for illustration purposes only and do not limit the extent and scope of the present invention. Further, as mentioned above, the present invention includes variations of the method and system, such as eliminating from the counts the SAOs appearing in the background and claims sections and displaying the net count of Ss-AOs-SAOs that appear in one or more of the title, abstract, summary of invention, and detailed description sections of each patent document.

The terms display and displayed, as used herein, pertain to data that is displayed and that can be displayed on a scrollable basis.

We claim:

1. In a digital computer system for accessing a plurality of natural language documents stored in a local or remote database comprising
acquiring a first set of documents in response to a user entered request,
the request including criteria identifying a first entity,
processing at least a portion of each document of said first set of documents into an SAO Knowledge Base, and
displaying at least a portion of the Ss or AOs in rank order of having the most to the least AOs or Ss, respectively, associated with the displayed Ss or AOs.

2. In a system according to claim 1 further including counting and displaying the total number of SAOs associated with said at least a portion of the Ss or AOs of said first set.

3. In a system according to claim 1 further including counting and displaying the total number of AOs or Ss associated with a particular S or AO, respectively, when said particular S or AO is selected by a user command.

4. In a system according to claim 1 wherein said criteria further includes a time period within which occurred some common event.

5. In a system according to claim 4 wherein said common event includes the filing of a patent application or publication of a technical document.

6. In a system according to claim 1 wherein said criteria further includes a characteristic of the entity's activity.

7. In a system according to claim 6 wherein said characteristic relates to a particular technical development, design, application, device, or process.

8. In a digital computer system for accessing a plurality of natural language documents stored in a local or remote database comprising
acquiring a first set and second set of documents in response to user entered requests,
each request including criteria identifying a first entity and a second entity,
processing at least a portion of each document of said first and second sets of documents into an SAO Knowledge Base and,
displaying in association with said first and second entity, respectively, at least a portion of the Ss or AOs of said first and second sets in rank order of having the most to the least AOs or Ss, respectively, associated with the displayed Ss or AOs.

9. In a system according to claim 8 wherein said Ss or AOs are displayed in first and second columns,
said first and second columns being associated with said first and second entities, respectively.

10. In a system according to claim 8 further including counting and displaying the total number of SAOs associated with said at least a portion of the Ss or AOs of said first and second sets, respectively.

11. In a system according to claim 8 further including counting and displaying the total number of AOs or Ss associated with a particular S or AO, respectively, when said particular S or AO is selected by a user command.

12. In a system according to claim 8 wherein said criteria further includes a time period within which occurred some common event.

13. In a system according to claim 12 wherein said common event includes the filing of a patent application or publication of a technical document.

14. In a system according to claim 8 wherein said criteria further includes a characteristic of the first and second entity's activity.

15. In a system according to claim 14 wherein said characteristic relates to a particular technical development, design, application, device, or process.

16. In a system according to claim 1 wherein the number of the source patents is displayed.

17. In a system according to claim 3 wherein the number of source patents are displayed related to said particular S or AO.

18. In a system according to claim 8 wherein the number of the source patents is displayed.

19. In a system according to claim 11 wherein the number of source patents are displayed related to said particular S or AO.
